(19) United States
(12) Patent Application Publication
(10) Pub. No.: US 2019/0266866 A1
(43) Pub. Date: Aug. 29, 2019

(54) ELECTRONIC TATTLETALE FOR ATM CASE INTRUSION

(71) Applicant: Capital One Services, LLC, McLean, VA (US)

(72) Inventor: David K. WURMFELD, Falls Church, VA (US)

(73) Assignee: Capital One Services, LLC, McLean, VA (US)

(21) Appl. No.: 15/903,880

(22) Filed: Feb. 23, 2018

(51) Int. Cl. G08B 13/26; G07F 19/00

(52) U.S. Cl. CPC G08B 13/26; G07F 19/205; G07F 19/207

(57) ABSTRACT

The disclosed embodiments provide systems, methods, and articles of manufacture for detecting an intrusion of a product (e.g., an ATM) via an electronic tattletale. The disclosed embodiments may provide an ATM comprising a housing and a detection circuit coupled to the housing. The detection circuit may detect that an intrusion into the housing has occurred based on a change in an electrical property of the housing. The ATM may also include one or more memory devices and processors configured to execute the instructions to detect an intrusion based on a change in capacitance. Systems and methods are also disclosed for manufacturing an ATM. The systems and method may include applying a substance to the interior of a housing of an ATM and coupling a detection circuit to the substance, the detection circuit detecting an intrusion into the housing based on a change in capacitance.

### TECHNICAL FIELD

The disclosed embodiments generally relate to device security and, more particularly, to systems, methods, and articles of manufacture for detecting intrusions into security products.

### BACKGROUND

An automated teller machine (ATM) is an electronic device that allows banking customers to carry out financial transactions without the need for a human teller. For example, customers may use an ATM to access their bank accounts, transfer funds, check account balances, or dispense items of value. Generally, to use an ATM, the customer may insert a banking card containing magnetic strip information into the ATM's card reader, and authenticate the card by entering a personal identification number (PIN). After the card has been read and authenticated, the customer can carry out various financial transactions.

While ATMs are convenient, their use can also be risky. Thieves often try to steal ATMs and break into them. After breaking into an ATM, thieves can access currency or checks held inside the ATM or manipulate the ATM's circuitry to dispense currency or checks automatically from the ATM.

Companies that manufacture or provide ATMs have been trying to prevent thieves from breaking into ATMs or provide some detection of intrusion into an ATM to alert law enforcement to catch the thieves. Current mechanisms exist for detecting an intrusion into an ATM, such as using motion detectors, accelerometers, or the like, in particular zones inside of the ATM. These mechanisms are often referred to in the industry as “tattletales,” mechanisms that “tattle,” that is, notify third parties when an intrusions is detected.

Thieves are now able to bypass these mechanisms using new techniques. For example, thieves are using common tools, such as lower-power cutting or drilling tools, to break into ATMs. In some instances, thieves may use cutting or drilling tools to create a hole in the housing of an ATM. After creating the hole, thieves will introduce flammable materials, such as acetylene gas, into the case igniting the materials cause the case to expand and blow apart the housing allowing access to currency inside of the ATM.

Common drilling and cutting tools bypass the current mechanisms because they create little motion and/or sound. Quite often, the motion and sound generated by these tools are undetectable to current mechanisms. Moreover, companies choose to place mechanisms in particularize zones due, in part, to cost constraints. With this in mind, thieves intelligently choose where to drill the holes, that is, thieves often choose to drill holes far enough away from current mechanisms so that the current mechanisms fail to detect the intrusion.

In view of these and other shortcomings and problems with existing systems, improved systems and techniques for manufacturing secure products and detecting intrusion into secure products are provided that are inexpensive and mitigate the risks of capital loss from thieves.

### SUMMARY

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

The disclosed embodiments address disadvantages of existing systems based on, at least, providing novel systems, methods, non-transitory computer-readable storage media, and articles of manufacture for detecting an intrusion into a secure device. Unlike prior implementations, the disclosed systems, methods, non-transitory computer-readable storage media, and articles of manufacture provide technical solutions that can be inexpensive (e.g., as related to the cost of the materials) and increase security (e.g., having the ability to detect an intrusion anywhere into the case and/or having the ability to detect intrusions that do not produce a lot of movement, vibrations, sound, etc.).

Consistent with a set of disclosed embodiments, an ATM is provided. For example, the ATM may comprise a housing comprising an exterior surface and an interior surface. In addition, the ATM may also comprise a substance adhered to the interior surface that, alone or in combination with the housing, forms a capacitor. The ATM may further comprise a detection circuit comprising a sensor coupled to the capacitor, the sensor detecting that an intrusion into the housing, based on a change in capacitance.

Consistent with another set of disclosed embodiments, an ATM is provided. For example, the ATM may comprise a housing having an interior surface and an exterior surface. The ATM may also comprise: a sensor; a substance adhered to the interior surface of the housing that, alone or in combination with the housing, forms a capacitor having a capacitance value; one or more memory devices storing instructions; and one or more processors. The one or more processor may be configured to execute the instructions to perform operations. For example, the operations may comprise detecting, via the sensor, a change in the capacitance value. The operations may further comprise detecting an intrusion based on the change in the capacitance value.

Consistent with yet another set of disclosed embodiments, systems and methods for manufacturing an ATM are provided. For example, the systems and methods may comprise applying a substance to an interior surface of a housing of an ATM, such that the substance, alone or in combination with the housing, forms a capacitor having a capacitance value. The systems and methods may also comprise coupling a detection circuit to the substance, the detection circuit comprising a sensor and detecting an intrusion into the housing, based on a change in the capacitance value.

Consistent with a set of disclosed embodiments, a product is provided. For example, the product may comprise a housing. In addition, the product may also comprise a detection circuit comprising a sensor coupled to the housing, the sensor detecting an intrusion into the housing, based on a change in an electrical property.

Consistent with another set of disclosed embodiments, another product is also provided. For example, the product may comprise a housing having an interior surface and an exterior surface. The product may also comprise: a sensor; a substance adhered to the interior surface of the housing, and alone or in combination with the housing, forming a capacitor having a capacitance value; one or more memory devices storing instructions; and one or more processors. The one or more processor may be configured to execute the instructions to perform operations. For example, the operations may comprise detecting, via the sensor, a change in the capacitance value. The operations may further comprise detecting an intrusion based on the change in the capacitance value.

Consistent with yet another set of disclosed embodiments, systems and methods for manufacturing a product are provided. For example, the systems and methods may comprise applying a substance to an interior surface of a housing of a product, such that the substance, alone or in combination, forms a capacitor having a capacitance value. The systems and methods may also comprise coupling a detection circuit to the substance, the detection circuit comprising a sensor and detecting an intrusion into the housing, based on a change in the capacitance value.

Aspects of the disclosed embodiments may also include a non-transitory tangible computer-readable medium that stores software instructions that, when executed by one or more processors, are configured for and capable of performing and executing one or more of the methods, operations, and the like, consistent with disclosed embodiments. It is to be understood that both the foregoing general description and the following detailed description are exemplary and explanatory only, and are not restrictive of the disclosed embodiments as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system environment for providing an electronic tattletale consistent with disclosed embodiments;

FIG. 2A is a schematic diagram of an exterior view of an exemplary automated teller machine (ATM) consistent with disclosed embodiments;

FIG. 2B is a schematic diagram of an interior view of an exemplary ATM consistent with disclosed embodiments;

FIG. 3 is a block diagram of an exemplary electronic tattletale consistent with disclosed embodiments;

FIG. 4 is a cross-sectional view of the ATM of FIGS. 2A and 2B consistent with disclosed embodiments;

FIG. 5 is a block diagram of an exemplary sensor analyzer consistent with disclosed embodiments;

FIG. 6 is a flowchart of an exemplary process for detecting an intrusion consistent with disclosed embodiments; and

FIG. 7 is a flowchart of an exemplary process for manufacturing an ATM consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

The disclosed embodiments generally relate to device security and, more particularly, to systems and methods for detecting intrusions into security products. As used herein the term “connected to” should be construed as touching, adhering to, resting on, attached to, fixed to, glued to, placed on, coupled, glancing, etc., and should be interpreted broadly.

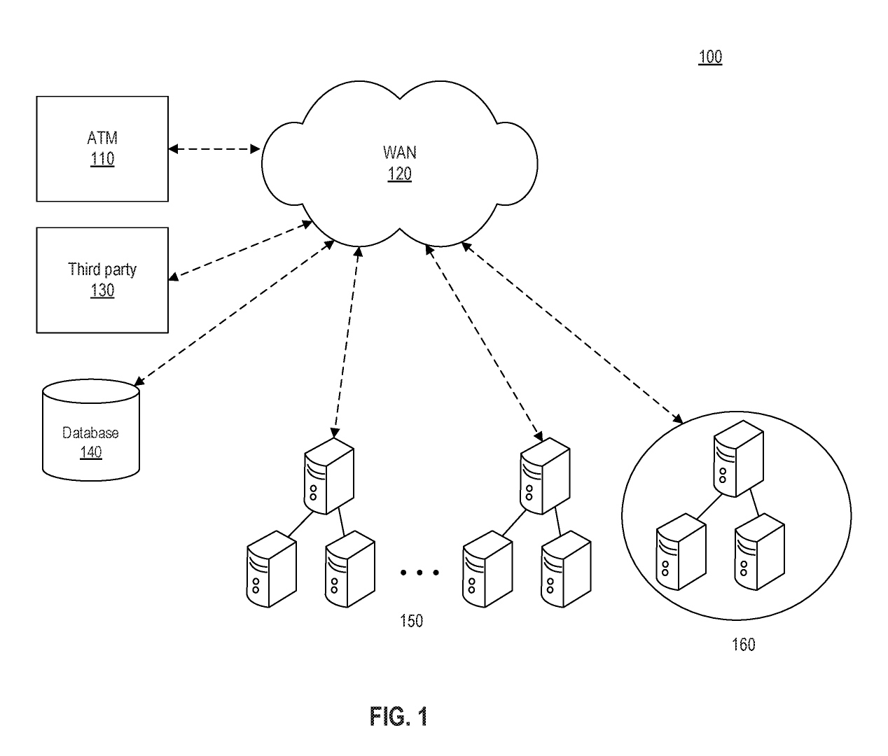

FIG. 1 is a block diagram of an exemplary system environment 100 for providing an electronic tattletale consistent with disclosed embodiments. The components and arrangements, shown in FIG. 1, are not intended to limit the disclosed embodiments, as the components used to implement the disclosed processes and features may vary.

System environment 100 may include one or more automated teller machines (ATMs) 110, wide-area networks (WANs) 120, third parties 130, databases 140, server clusters 150, and/or cloud services 160. Other components known to one of ordinary skill in the art may be included in system environment 100 to gather, process, transmit, receive, acquire, and provide information used in conjunction with the disclosed embodiments. In addition, system environment 100 may further include other components that perform or assist in the performance of one or more processes that are consistent with disclosed embodiments.

An ATM may be construed as any machine that is capable of carrying out transaction instructions, which include the transfers of value. In some embodiments, other types of systems, devices, or products (not depicted) may replace ATM 110. For example, the disclosed embodiments may include any product that encloses any type of physical materials, systems, devices, products, and/or articles of manufacture. For example, a product may include any type of door, gate, lock, safe, etc.

ATM 110 may include one or more housings, fasciae, processors, memory devices, and/or circuits. The processors, memory devices, and circuits may work together, in different combinations, to dispense currency, accept deposits, make account balance inquiries, pay bills, transfer funds, and/or the like. ATM 110 may also dispense media, currency, and/or documents. These media and documents may include tickets, vouchers, checks, gaming materials, notes, receipts, etc. Users (e.g., customers, consumers, etc.) may operate ATM 110. In some embodiments, ATM 110 may be associated with merchants, merchant devices, financial service providers, and/or financial service provider devices.

WAN 120 may comprise any computer networking arrangement used to exchange data. For example, WAN 120 may be the Internet, a private data network, a virtual private network (VPN) using a public network, and/or other suitable connections that enable the components of system environment 100 to send and acquire information. WAN 120 may also include a public switched telephone network (“PSTN”) and/or a wireless network such as a cellular network, wired Wide Area Network, Wi-Fi network, or another known wireless network (e.g., WiMAX) capable of bidirectional data transmission.

WAN 120 may also include one or more local networks (not pictured). A local network may be used to connect the components of FIG. 1, such as ATM 110, third party 130, database 140, server cluster 150, and/or cloud service 160, to WAN 120. A local network may comprise any type of computer networking arrangement used to exchange data in a localized area, such as Wi-Fi based on IEEE 802.11 standards, Bluetooth™, Ethernet, and other suitable network protocols that enable components of system environment 100 to interact with one another and to connect to WAN 120 for interacting with components in system environment 100. In some embodiments, a local network comprises a portion of WAN 120. In other embodiments, components of system environment 100 may communicate via WAN 120 without a separate local network.

Third party 130 may be a company, an individual, or a device, and may include a financial service provider, financial service provider device, merchant, merchant device, person standing next to ATM 110, law enforcement entity, law enforcement device, etc. Third party 130 may be associated with, be responsible for, own, or lease ATM 110. In addition, third party 130 may be configured to perform one or more operations consistent with disclosed embodiments.

Database 140 may include one or more memory devices that store information. By way of example, database 140 may include Oracle™ databases, Sybase™ databases, or other relational databases or non-relational databases, such as Hadoop sequence files, HBase™ or Cassandra™. The databases or other files may include, for example, data and information related to the source and destination of a network request, the data contained in the request, etc. Systems and methods of disclosed embodiments, however, are not limited to separate databases. Database 140 may include computing components (e.g., database management system, database server, etc.) configured to acquire and process requests for data stored in memory devices of database 140 and to provide data from database 140.

Server cluster 150 may be located in the same data center or different physical locations. Multiple server clusters 150 may be formed as a grid to share resources and workloads. Each server cluster 150 may include a plurality of linked nodes operating collaboratively to run various applications, software modules, analytical modules, rule engines, etc. Each node may be implemented using a variety of different equipment, such as a supercomputer, personal computer, server, mainframe, mobile device, or the like. In some embodiments, the number of servers and/or server cluster 150 may be expanded or reduced based on workload. In some embodiments, one or more components of system environment 100 (including one or more server clusters 150) may be placed behind a load balancer to support high availability and ensure real-time (or near real-time) processing of optimal decision predictions.

Cloud service 160 may include a physical and/or virtual storage system associated with cloud storage for storing data and providing access to data via a public network such as the Internet. Cloud service 160 may include cloud services such as those offered by, for example, Amazon®, Apple®, Cisco®, Citrix®, IBM®, Joyent®, Google®, Microsoft®, Rackspace®, Salesforce.com®, and Verizon®/Terremark®, or other types of cloud services accessible via WAN 120. In some embodiments, cloud service 160 comprises multiple computer systems spanning multiple locations and having multiple databases or multiple geographic locations associated with a single or multiple cloud storage service(s). As used herein, cloud service 160 refers to physical and virtual infrastructure associated with a single cloud storage service and may manage and/or store data associated with managing tip recommendations.

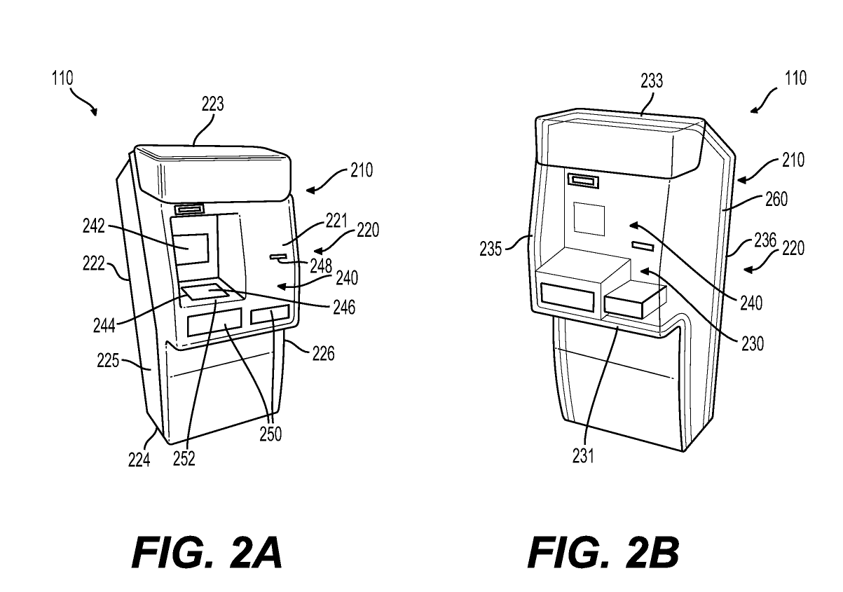

FIGS. 2A and 2B show exterior and interior views of ATM 110, with an electronic tattletale consistent with disclosed embodiments. ATM 110 may include a housing 210 that may encase valuables, such as currency, checks, deposit slips, etc., and/or electronic components, such as processors, memory devices, circuits, etc. Housing 210 may be made of various materials, including plastics, metals, polymers, woods, ceramics, concretes, paper, glass, etc. In some embodiments, housing 210 may have a different shape than the one shown in FIGS. 2A and 2B.

Housing 210 may include exterior housing surface 220 and interior housing surface 230. Exterior housing surface 220 may include one or more surfaces. For example, exterior housing surface 220 may include a front surface 221, back surface 222, top surface 223, bottom surface 224, left surface 225, and right surface 226. Interior housing surface 230 may also include one or more surfaces. For example, interior housing surface 230 may include a front surface 231, back surface 232, top surface 233, bottom surface 234, left surface 235, and right surface 236. The number of surfaces of exterior housing surface 220 and/or interior housing surface 230 is not limited by the present disclosure.

Exterior housing surface 220 may be made of the same material as interior housing surface 230. In some embodiments, exterior housing surface 220 may be made of a different material than interior housing surface 230. In some embodiments, exterior housing surface 220 and/or interior housing surface 230 may have one or more additional materials connected to it.

In some embodiments, housing 210 may include fascia 240. In some embodiments, fascia 240 may be connected to any surface of exterior housing surface 220 and/or interior housing surface 230. As depicted, for illustrative purposes only, fascia 240 is connected to front surface 221 of exterior housing surface 220. Fascia 240 may also be connected to multiple surfaces of exterior housing surface 220 and/or interior housing surface 230. Fascia 240 may be made of a different material than exterior housing surface 220 and/or interior housing surface 230. For example, fascia 240 may be made of plastic while exterior housing surface 220 and/or interior housing surface 230 may be made of sheet metal.

Fascia 240 may include components, such as one or more displays 242, key panels 244, function keys 246, card readers 248, slots 250, and/or writing shelves 252. The components of fascia 240 are only illustrative. Other components may be included in ATM 110. In some embodiments, components, such as those shown in FIG. 2, may be replaced with other components or deleted from ATM 110.

Display 242 may include a Thin Film Transistor Liquid Crystal Display (LCD), In-Place Switching LCD, Resistive Touchscreen LCD, Capacitive Touchscreen LCD, an Organic Light Emitted Diode (OLED) Display, an Active-Matrix Organic Light-Emitting Diode (AMOLED) Display, a Super AMOLED, a Retina Display, a Haptic or Tactile touchscreen display, or any other display. Display 242 may be any known type of display device that presents information to a user operating ATM 110. Display 242 may be a touchscreen display, which allows the user to input instructions to display 242. Other components, such as key panels 224, function keys 246, card readers 248, and/or slots 250 may allow the user to input instructions to display 242.

Card reader 248 may allow a user to, in some embodiments, insert a transaction card into ATM 110. The transaction card may be associated with a financial service provider. Card reader 248 may allow ATM 110 to acquire and/or collect transaction information from the transaction card. In some embodiments, card reader 248 may allow a user to tap a transaction card or mobile device in front of card reader 248 to allow ATM 110 to acquire and/or collect transaction information from the transaction card via technologies, such as near-field communication (NFC) technology, Bluetooth™ technology, and/or radio-frequency identified technology, and/or wireless technology. Card reader 248 may also be connected with a mobile application that allows the user to transfer transaction card information to card reader 248 and/or ATM 110 with or without inserting the transaction card.

Slots 250 may include one or more card slots (which may be connected to card reader 248), receipt slots, deposit slots, mini account statement slot, cash slot, etc. Slots 250 may allow a user of ATM 110 to insert or receive one or more receipts, deposits, withdrawals, mini account statements, cash, checks, money orders, etc.

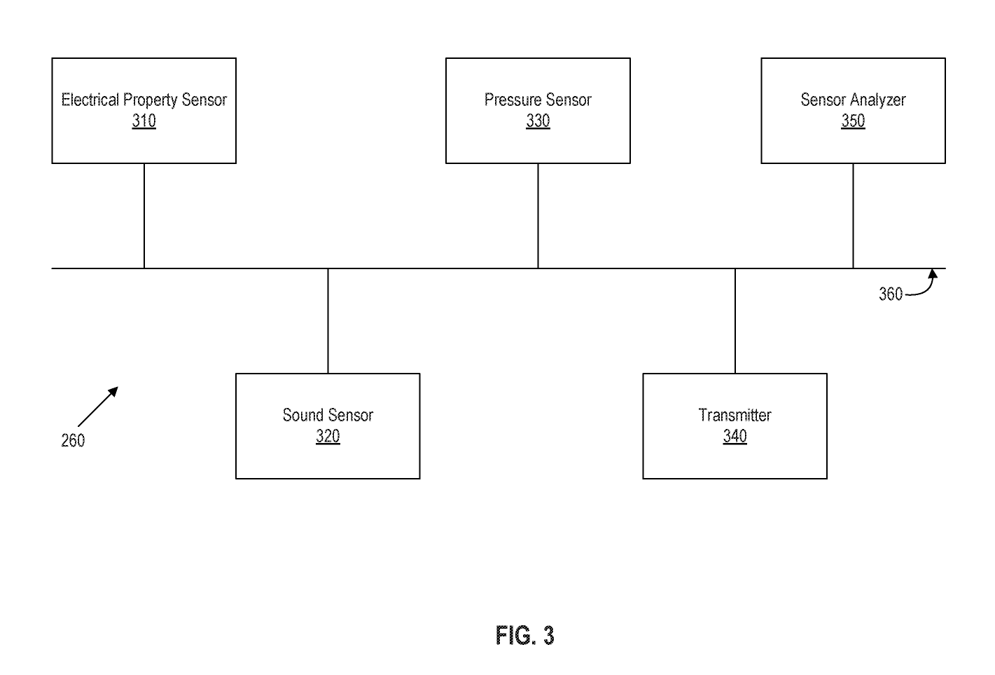

Interior housing surface 230 may include an electronic tattletale 260. One or more components of tattletale 260, as discussed in FIG. 3, may be connected to interior housing surface 230 and other parts may be enclosed in interior housing surface 230 or outside of exterior housing surface 220. In some embodiments, substantially all components of tattletale 260 may be connected to and/or enclosed in interior housing surface 230.

FIG. 3 is a block diagram illustrating a tattletale 260 (e.g., “a detection circuit”) consistent with disclosed embodiments. Tattletale 260 may include components, such as an electrical property sensor 310, a sound sensor 320, a pressure sensor 330, a transmitter 340, and/or a sensor analyzer 350. In some embodiments, one or more components of tattletale 260 may be interconnected via a bus 360 to communicate bidirectionally with each other. One or more components of tattletale 260 may also be connected wirelessly via one or more wireless receivers (not shown) to communicate bidirectionally with each other.

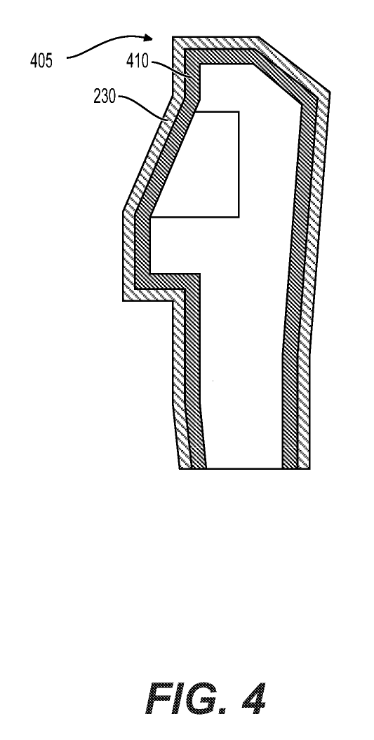

Electrical property sensor 310 (e.g., a capacitance sensor) may be coupled to hardware components, such as resistors, transistors, capacitors, inductors, semiconductors, sensors, etc., and/or software programs. Turning to FIG. 4, electrical component 405 may be connected to electrical property sensor 310 (not shown). Electrical component 405 may comprise substance 410 and/or interior housing surface 230. For example, electrical component 405 may be a capacitor that is formed when substance 410 is connected to interior housing surface 230 or electrical component 405 may be a capacitor that is formed by substance 410 itself. Electrical property sensor 310 may be coupled to electrical component 405. For example, electrical property sensor 310 may be coupled to interior housing surface 230 via substance 410, that is, electrical property sensor 310 may be connected to substance 410 and substance 410 may be connected to interior housing surface 230.

Substance 410 may be connected to the entirety of interior housing surface 230 (which includes all surfaces of interior housing surface 230), the entirety of one more surfaces of interior housing surface 230, a part of one or more of surfaces of interior housing surface 230, a part of interior housing surface 230, etc. After being connected to interior housing surface 230, the total thickness of substance 410 may be 5 mm or less. In some embodiments, substance 410 may be formed of one or more different materials than interior housing surface 230 to form electronic component 405. For example, substance 410 may be a dielectric (such as a polymer or ceramic material) while interior housing surface 230 may be a conductor (such as a metal) or substance 410 may be a conductor while interior housing surface 230 may be a dielectric.

Substance 410, alone or in combination with interior housing surface 230, may have non-zero electrical properties, such as a charge, resistance, capacitance, conductance, etc. In some embodiments, as described above, substance 410 may be electrical component 405 (e.g., a capacitor, resistor, etc.). However, in some embodiments, substance 410, by being connected with interior housing surface 230, may form an electrical component 405; thus, it is to be understood that the properties with respect to the properties of substance 410 and/or interior housing surface 230 below may also apply to properties of interior housing surface 230 in combination with substance 410.

Substance 410, alone or in combination with interior housing surface 230, (e.g., electronic component 405) may comprise a multi-layered ceramic capacitor, a ceramic capacitor disc, a ceramic capacitor tubular, a plastic film capacitor, a paper capacitor, a mica capacitor, etc. Substance 410 may be sprayed and/or dispersed onto interior housing surface 230 to form a coating. For example, substance 410 may be a multi-layered ceramic capacitor that is sprayed and/or dispersed onto interior housing surface 230 that is made of sheet metal to form electronic component 405. Substance 410, in some embodiments, may be a molded insert. In some embodiments, the molded insert may be capacitive and or formed using standard composite forming techniques. The molded insert may conform to the fascia 240 of ATM 110. In some embodiments, the thickness of substance 410 may be 5 mm or less.

Turning back to FIG. 3, electrical property sensor 310 may detect a change in an electrical property of electrical component 405. As described above, electrical component 405 may be a hardware component (e.g., a capacitor) that is formed when substance 410 is connected to interior housing surface 230 or electrical component 405 may be a hardware component (e.g., a capacitor) that is formed by substance 410 itself. Electrical property sensor 310, alone or in combination with sensor analyzer 350, may detect the intrusion based on a change in the capacitance value of electrical component 405. Electrical property sensor 310, alone or in combination with sensor analyzer 350, may detect insertion of tools, such as drilling and/or cutting tools, into housing 210. These tools may change the capacitance of electrical component 405. In some embodiments, these tools may affect a change in capacitance of electrical component 405 as small as 1.0 picofarad, which electrical property sensor 310, alone or in combination with sensor analyzer 350, may detect.

In some embodiments, tattletale 260 may include other sensors (including sensors not depicted in FIG. 3. As shown in FIG. 3, tattletale 260 may include sound sensor 320. Sound sensor 320, alone or in combination with sensor analyzer 350, may detect changes in sound. In some embodiments, sound sensor 320 may detect quiet sounds, such as sounds generated by a low-powered drilling or cutting tool. Sound sensor 320, alone or in combination with sensor analyzer 350, may also detect other sounds, such as those from an object tapping, being placed on, and/or being attached to ATM 110. In some embodiments, sound sensor 320 may detect vibrations or the movement of ATM 110, which may also detect sound.

Sound sensor 320, alone or in combination with sensor analyzer 350, may use surface acoustic wave detection techniques to detect the change in sound. For example, sound sensor 320 may include one or more surface acoustic wave sensors. The one or more surface acoustic wave sensors may rely on the modulation of surface acoustic waves to sense a physical change, such as a change in temperature, mass, vibration, etc., of ATM 110. Sound sensor 320, alone or in combination with sensor analyzer 350, may detect the intrusion based on one or more signals generated by the surface acoustic wave sensor.

In some embodiments, sound sensor 320 may be coupled to electrical property sensor 310. Sound sensor 320 may detect an intrusion of housing 210 alone, in combination with sensor analyzer 350, and/or in combination with another sensor in FIG. 3 (e.g., electrical property sensor 310, pressure sensor 330, etc.). Sound sensor 320, alone or in combination with sensor analyzer 350, may verify the intrusion based on determining that the change in sound exceeds a predetermined threshold. In some embodiments, sound sensor 320 and/or electrical property sensor 310 may utilize transmitter 340 to transmit an intrusion alert signal upon detection or the verification that an intrusion has occurred.

In some embodiments, tattletale 260 may include, additionally or alternatively, pressure sensor 330. Pressure sensor 330, alone or in combination with sensor analyzer 350, may detect changes in pressure. Pressure sensor 330 may be coupled to a pressurized bladder (not pictured) connected to interior housing surface 230. Pressure sensor 330, alone or in combination with sensor analyzer 350, may detect a change in the pressure of the pressurized bladder. For example, when a drilling or cutting tool shifts or pierces the pressurized bladder, the pressure of the pressurized bladder may change and pressure sensor 330, alone or in combination with sensor analyzer 350, may detect that change. In some embodiments, pressure sensor 330 may include one or more piezoelectric transducers and/or pressure sensors, to detect a change in the pressure of the pressurized bladder and/or housing 210.

Pressure sensor 330 may be coupled to electrical property sensor 310. Pressure sensor 330, alone or in combination with sensor analyzer 350, may detect an intrusion of housing 210 alone. On the other hand, pressure sensor 330, alone or in combination with sensor analyzer 350, may detect an intrusion of housing 210, along with other sensors in FIG. 3. In some embodiments, pressure sensor 330, alone or in combination with sensor analyzer 350, may verify an intrusion detected by other sensors in FIG. 3 (e.g., electrical property sensor 310, sound sensor 320, etc.). Pressure sensor 330, alone or in combination with sensor analyzer 350, may verify the intrusion based on determining that the change in sound exceeds a predetermined threshold. In some embodiments, pressure sensor 330 and/or electrical property sensor 310, alone or in combination with sensor analyzer 350, may utilize transmitter 340 to transmit an intrusion alert signal upon detection or the verification that an intrusion has occurred.

Although not shown, other sensors, alone or in combination with sensor analyzer 350, may be used in tattletale 260 to detect or verify an intrusion into housing 210. The other sensors, alone or in combination with sensor analyzer 350, may be used to detect changes, such as changes in temperature, movement, location, etc., of all or parts of housing 210. In addition, the other sensors may utilize transmitter 340, alone or in combination with sensor analyzer 350, to transmit an intrusion alert signal upon detection or the verification that an intrusion has occurred.

Tattletale 260 may include, additionally or alternatively, transmitter 340. Transmitter 340 may transmit an alert, such as a sound, light, email, alert, message, telephone call, radio signal, etc., to third party 130. Third party 130 may or may not be associated with ATM 110. Transmitter 340, alone or in combination with sensor analyzer 350, may transmit an alert via hardware or software. Transmitter 340 may also be located on exterior housing surface 220. In some embodiments, transmitter 340 may transmit messages via one or more components of fascia, such as display 242 or slot 250. Transmitter 340 may transmit alerts using technologies, such as near-field communication (NFC) technology, Bluetooth™ technology, radio-frequency identified technology, wireless technology, hardware technology (e.g., infrared lights, microphones, speakers, etc.).

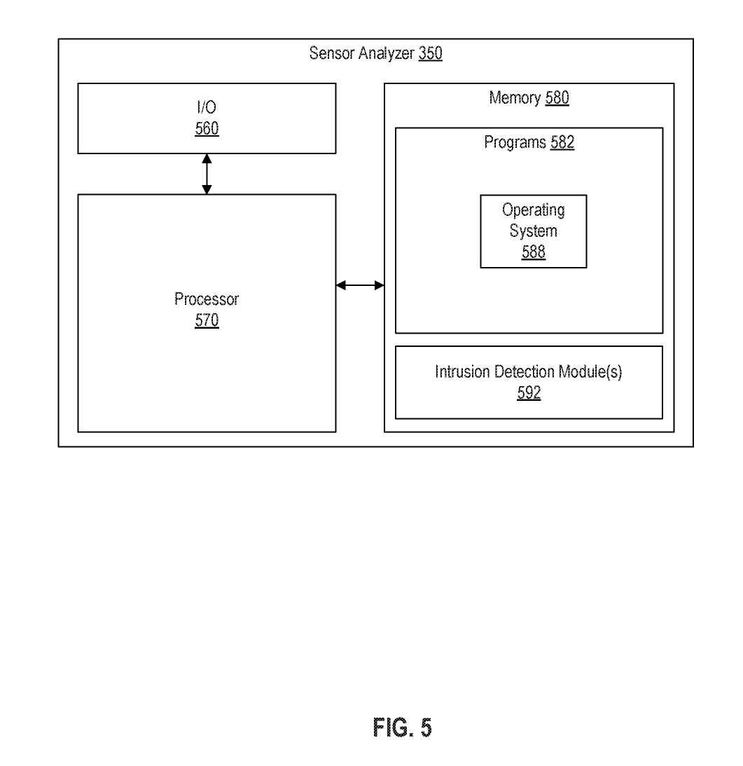

Referring now to FIG. 5, tattletale 260 (FIG. 3) may, additionally or alternatively, include sensor analyzer 350. Sensor analyzer 350 may detect an intrusion into housing 210, alone or in combination, with other components of FIG. 3. As shown in FIG. 5, sensor analyzer 350 may include one or more input/output (“I/O”) devices 560, processors 570, and memory devices 580 storing data and programs 582 (including, for example, operating system 588 and instruction detection module 592). The logic or programs of sensor analyzer 350 can be implemented in hardware, software, and/or a combination thereof.

Sensor analyzer 350 may also include one or more I/O devices 560 that may comprise one or more interfaces for receiving input (e.g., signals from either or both of sound sensor 320 and pressure sensor 330) or output to either or both of sound sensor 320 and pressure sensor 330 in FIG. 3. Processor 570 may be one or more known or custom processing devices designed to perform functions of the disclosed methods, such as a single core or multiple core processors capable of executing parallel processes simultaneously. For example, processor 570 may be configured with virtual processing technologies. In certain embodiments, processor 570 may use logical processors to execute and control multiple processes simultaneously. Processor 570 may implement virtual machine technologies, including a Java® Virtual Machine, or other known technologies to provide the ability to execute, control, run, manipulate, store, etc., multiple software processes, applications, programs, etc. In another embodiment, processor 570 may include a multiple-core processor arrangement (e.g., dual core, quad core, etc.) configured to provide parallel processing functionalities to allow sensor analyzer 350 to execute multiple processes simultaneously. One of ordinary skill in the art would understand that other types of processor arrangements could be implemented that provide for the capabilities disclosed herein.

Sensor analyzer 350 may include memory device 580 configured to store information used by processor 370 (or other components) to perform certain functions related to the disclosed embodiments. In one example, memory device 580 may comprise one or more storage devices that store instructions to enable processor 570 to execute one or more applications, such as server applications, network communication processes, and any other type of application or software known to be available on computer systems. Alternatively or additionally, the instructions, application programs, etc., may be stored in an internal database or external storage (not shown) in direct communication with sensor analyzer 350, such as one or more database or memory accessible over WAN 120. The internal database and external storage may be a volatile or non-volatile, magnetic, semiconductor, tape, optical, removable, non-removable, or another type of storage device or tangible (e.g., non-transitory) computer-readable medium.

Sensor analyzer 350 may also be communicatively connected to one or more remote memory devices (e.g., remote databases (not shown)) through WAN 120 or a different network. The remote memory devices may be configured to store information (e.g., structured, semi-structured, and/or unstructured data) and may be accessed and/or managed by sensor analyzer 350. By way of example, the remote memory devices may be document management systems, Microsoft® SQL database, SharePoint® databases, Oracle® databases, Sybase™ databases, or other relational databases. Systems and methods consistent with disclosed embodiments, however, are not limited to separate databases or even to the use of a database.

In certain embodiments, sensor analyzer 350 may include memory device 580 that includes instructions that, when executed by processor 570, perform one or more processes consistent with the functionalities disclosed herein. Methods, systems, and articles of manufacture consistent with disclosed embodiments are not limited to separate programs or computers configured to perform dedicated tasks. For example, sensor analyzer 350 may include memory device 580 that stores instructions constituting one or more programs 582 and/or intrusion detection module(s) 592 to perform one or more functions of the disclosed embodiments. Moreover, processor 370 may execute one or more programs located remotely on system environment 100. For example, sensor analyzer 350 may access one or more remote programs, that, when executed, perform functions related to disclosed embodiments.

Memory device 580 may include one or more memory devices that store data and instructions used to perform one or more features of the disclosed embodiments. For example, memory device 580 may represent a tangible and non-transitory computer-readable medium having stored therein computer programs, sets of instructions, code, or data to be executed by processor 570. Memory device 580 may include, for example, a removable memory chip (e.g., EPROM, RAM, ROM, DRAM, EEPROM, flash memory devices, or other volatile or non-volatile memory devices) or other removable storage units that allow instructions and data to be accessed by processor 570.

Memory device 580 may also include any combination of one or more relational and/or non-relational databases controlled by memory controller devices (e.g., server(s), etc.) or software, such as document management systems, Microsoft® SQL database, SharePoint® databases, Oracle® databases, Sybase™ databases, other relational databases, or non-relational databases, such as key-value stores or NoSQL™ databases, such as Apache HBase™. In some embodiments, memory device 580 may comprise associative array architecture, such as a key-value storage, for storing and rapidly retrieving large amounts of information.

Programs 582 stored in memory device 580 and executed by processor(s) 570 may include one or more operating system 588. Programs 582 may also include one or more machine learning, trending, and/or pattern recognition applications (not shown) to detect an intrusion into housing 210. For example, one or more machine learning, trending, and/or pattern recognition applications may provide, modify, or suggest input variables associated with one or more other programs 582.

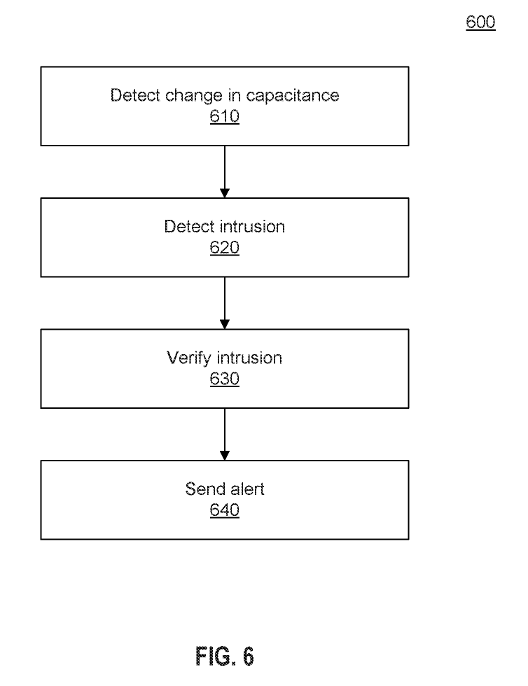

FIG. 6 is a flowchart illustrating an exemplary process 600 for detecting an intrusion into housing 210 consistent with disclosed embodiments. Sensor analyzer 350, via intrusion detection module(s) 592, may implement the steps, as illustrated in the flowchart. However, the steps illustrated in the flowchart are only exemplary. One or more steps may be added or deleted to detect an intrusion into housing 210. The steps of FIG. 6 may be implemented via hardware via one or more of the sensors (e.g., electrical property sensor 310, sound sensor 320, pressure sensor 330, etc.), as described above with respect to FIG. 3.

At step 610, intrusion detection module 592 may detect a change in the capacitance of, for example, electrical component 405. For example, intrusion detection module 592 may detect the change in capacitance by obtaining one or more capacitance values of electrical component 405 (e.g., via electrical property sensor 310). Intrusion detection module 592 may obtain the capacitance values by acquiring, receiving, and/or reading the capacitance of electrical component 405. In some embodiments, intrusion detection module 592 may obtain capacitance values by calculating the capacitance of electrical component 405 from other electrical properties and/or components of electrical property sensor 310.

At step 620, intrusion detection module 592 may detect an intrusion based on the change in capacitance. Intrusion detection module 592 may detect the intrusion based on determining that a difference between capacitance values exceeds a predetermined threshold. Intrusion detection module 592 may also detect the intrusion based on determining that an absolute value of a difference between the capacitance values exceeds a predetermined threshold. The predetermined threshold value may indicate the smallest amount of change in capacitance before an intrusion can be determined.

If intrusion detection module 592 detects an intrusion based on the change in capacitance, intrusion detection module 592 may verify that an intrusion has occurred (at step 630). In some embodiments, intrusion detection module 592 may detect a change in sound based on detecting a change in a measurement made by an surface acoustic wave sensor via sound analyzer 320 (using techniques similar to step 610) and verify the intrusion based on determining that the change in sound exceeds a predetermined threshold (using techniques similar to step 620). In certain embodiments, intrusion detection module 592 may detect a change in pressure based on a change in a measure made by one or more piezoelectric transducers and/or pressurized bladders via pressure analyzer 330 (using techniques similar to step 610) and verify the intrusion based on determining that the change in pressure exceeds a predetermined threshold (using techniques similar to step 620).

At step 640, intrusion detection module 592 may send an alert to third party 130 if intrusion detection module 592 detects an intrusion based on the change in capacitance and/or verifies that an intrusion has occurred. Intrusion detection module 592 may or may not send the alert via transmitter 340. In some embodiments, intrusion detection module 592 may send the alert to third party 130 who is associated with law enforcement. In some embodiments, intrusion detection module 592 may send the alert to third party 130 who is associated with ATM 110. In certain embodiments, intrusion detection module 592 may send more than one alert. The alert may be silent and not visible to a potential intruder.

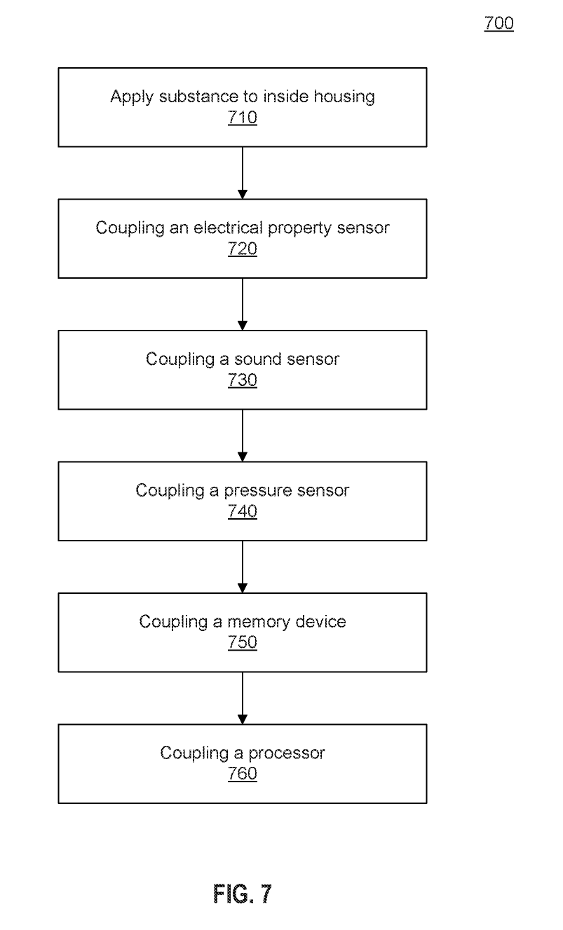

FIG. 7 is a flowchart of an exemplary process 700 for manufacturing ATM 110 consistent with disclosed embodiments. One or more steps may be added or deleted from process 700. At step 710, process 700 may include applying substance 410 to interior housing surface 230. Substance 410, alone or in combination with interior housing surface 230, may form electrical component 405 (e.g., a capacitor). Additionally, at step 720, process 700 may include coupling a detection circuit comprising components, such as electrical property sensor 310, to electrical component 405 (e.g., substance 410 and/or interior housing surface 230).

Although the disclosed embodiments have been described in relation to ATM 110, other products may also be designed to disclose the same features as disclosed above. The other products may relate to any product that is used to secure something inside of the product. To illustrate the far-reaching range of possible products, a few example products follow:

security devices, such as safes, vaults, fireboxes, jewelry boxes, etc.;

transportation devices, such as car doors, trunks, etc.;

electronic devices, such as computers, phones, etc.; and

entry devices, such as smart locks, doors, cockpits, garage doors, etc.

The described techniques may be varied and are not limited to the examples or descriptions provided. In some embodiments, some or all of the logic for the above-described techniques may be implemented as a computer program or application, as a plug-in module or sub-component of another application, or as hardware components.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. The claims are to be interpreted broadly based on the language employed in the claims and not limited to examples described in the present specification. Accordingly, the examples presented herein are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above-described examples but, instead, are defined by the appended claims in light of their full scope of equivalents.

1. An automated teller machine (ATM), comprising:
a housing comprising an exterior surface and an interior surface;
a pressure device connected to the interior surface of the housing, the pressure device comprising an internal volume having an internal air pressure different than ambient air pressure, and the pressure device being configured to detect a change in air pressure of the internal volume;
a substance adhered to the interior surface, the substance and the housing, in combination, forming a capacitor; and
a detection circuit coupled to the capacitor and the pressure device, the detection circuit being configured to
detect an intrusion into the housing based on a change in capacitance of the capacitor exceeding a predetermined threshold, and
verify the intrusion based on the change in air pressure.

2. The ATM of claim 1, wherein the substance is a molded insert adhered to the interior surface, and wherein the molded insert is less than 5 millimeters thick.

3. The ATM of claim 1, wherein the substance is adhered to the interior surface by coating the substance onto the interior surface, and wherein the coating is less than 5 millimeters thick.

4. The ATM of claim 1, wherein the substance adheres to an entirety of the interior surface of the housing.

5. The ATM of claim 1, wherein the capacitor comprises at least one of a multi-layered ceramic structure, a ceramic capacitor tubular, a plastic film capacitor, a paper capacitor, or a mica capacitor.

6. The ATM of claim 1, wherein:
the capacitor has a first capacitance value; and
the detection circuit is configured to:
acquire a second capacitance value of the capacitor, the second capacitance value being different from the first capacitance value;
determine an absolute value of a difference between the first and second capacitance values; and
detect that the intrusion has occurred, based on a determination that the difference exceeds the predetermined threshold.

7. The ATM of claim 1, further comprising a transmitter coupled to the detection circuit, the transmitter transmitting an intrusion alert signal upon detection that the intrusion has occurred.

8. An automated teller machine (ATM), comprising:
a housing having an interior surface and an exterior surface;
a pressure device connected to the interior surface and configured to measure an air pressure value of an internal volume, the internal volume having an internal air pressure different than ambient air pressure;
a sensor;
a substance adhered to the interior surface of the housing, the substance, and the housing, in combination, forming a capacitor having a capacitance value;
one or more memory devices storing instructions; and
one or more processors configured to execute the instructions to perform operations comprising:
detecting, via the pressure device, a change in the air pressure value;
detecting, via the sensor, a change in the capacitance value; and
detecting the intrusion based on the change in the capacitance value, and
verifying the intrusion based on the change in the air pressure value.

9. The ATM of claim 8, wherein the substance is a molded insert adhered to the interior surface, and wherein the molded insert is less than 5 millimeters thick.

10. The ATM of claim 8, wherein the substance adhered to the interior surface by coating the substance onto the interior surface, and wherein the coating is less than 5 millimeters thick.

11. The ATM of claim 8, wherein the substance adheres to an entirety of the interior surface of the housing.

12. The ATM of claim 8, wherein the capacitor comprises at least one of a multi-layered ceramic structure, a ceramic capacitor tubular, a plastic film capacitor, a paper capacitor, or a mica capacitor.

13. The ATM of claim 8, wherein the operations further comprise:
detecting the intrusion by:
obtaining, via the sensor, a first capacitance value of the capacitor;
obtaining, via the sensor, a second capacitance value of the capacitor;
determining that a difference between the first and second capacitance value exceeds a predetermined threshold; and
detecting the intrusion based on the determination that the difference exceeds the predetermined threshold.

14. The ATM of claim 8, wherein the operations further comprise sending an intrusion alert signal upon detection of the intrusion.

15. A method for manufacturing an automated teller machine (ATM), the method comprising:
applying a pressure device to an interior surface of a housing of the ATM, such that the pressure device is configured to measure an air pressure value of an internal volume, the internal volume having an internal air pressure different than ambient air pressure;
applying a substance to the interior surface, such that the substance and the housing, in combination, form a capacitor having a capacitance value; and
coupling a detection circuit to the substance and the pressure device, the detection circuit being configured to:
detect the intrusion into the housing, based on a change in the capacitance value, and
verify the intrusion based on a change in the air pressure value.

16. The method of claim 15, wherein the substance is a molded insert less than 5 millimeters thick, and the substance is applied to the interior surface by adhering the molded insert to the interior surface.

17. The method of claim 15, wherein the substance applied to the interior surface by coating the substance onto the interior surface, and wherein the coating is less than 5 millimeters thick.

18. The method of claim 15, wherein the substance is applied to an entirety of the interior surface of the housing.

19. The method of claim 15, wherein the capacitor comprises at least one of a multi-layered ceramic structure, a ceramic capacitor tubular, a plastic film capacitor, a paper capacitor, or a mica capacitor.

20. The method of claim 15, further comprising transmitting an intrusion alert signal upon detection that the intrusion has occurred.
